(19) United States
(12) Patent Application Publication
(10) Pub. No.: US 2026/0033462 A1
(43) Pub. Date: Feb. 5, 2026

(54) SYSTEMS AND METHODS FOR DEEP LEARNING-BASED PET HEALTH PREDICTIONS

(71) Applicant: Tractive Inc., Seattle, WA (US)

(72) Inventor: Lukmaan Abbas BAWAZER, Oakland, CA (US)

(21) Appl. No.: 19/289,651

(22) Filed: Aug. 4, 2025

Related U.S. Application Data
(60) Provisional application No. 63/679,247, filed on Aug. 5, 2024.

(51) Int. Cl. A01K 29/00; G06N 3/0455

(52) U.S. Cl. CPC A01K 29/007; A01K 29/002; G06N 3/0455

(57) ABSTRACT

A method for predicting pet health conditions includes receiving activity data generated by at least one sensor device configured to detect activity of a pet, determining behavior data indicative of a plurality of behaviors of the pet based on the activity data, receiving a trained neural architecture for a representation model configured to facilitate health condition predictions and another neural architecture for a classification model configured to predict a health condition of the pet based at least in part on the behavior data, predicting, using the trained neural architecture, presence of the health condition of the pet, and causing a user device to display a notification including information identifying the health condition.

### CROSS-REFERENCE TO RELATED APPLICATION(S)

This patent application claims the benefit of priority to U.S. Provisional Application No. 63/679,247, filed on Aug. 5, 2024, the entirety of which is incorporated herein by reference.

### TECHNICAL FIELD

The present disclosure generally relates to methods and systems for predicting pet health conditions, and, more particularly, to methods and systems using machine learning neural architectures for predicting pet health conditions.

### BACKGROUND

Pet healthcare is an increasingly important field as modern developments have increased the quality and accessibility of pet care. For various reasons, pet health conditions may be difficult to diagnose, especially during early stages of a condition. For example, pets may hide symptoms, owners may not notice or appreciate the severity of behavioral changes, or owners may be reluctant to involve a veterinarian for an issue that appears to be minor.

Modern devices facilitate collection of a wide array of data relating to pet activity and behavior. For example, so-called “smart” collars use various sensors, such as accelerometers, to detect pet motion data. Similarly, cameras have become increasingly prevalent in homes and may be used to observe pet behaviors even when the pet owner is not present. Knowledge of these behaviors can assist the pet owner or a care provider in monitoring changes in a pet's routine, or identifying the onset of a change in a pet's health or lifestyle.

This disclosure is directed to methods and systems for leveraging data collection by smart collars, cameras, and similar devices to identify behaviors that may be indicative of a health-related condition. The background description provided herein is for the purpose of generally presenting the context of the disclosure. Unless otherwise indicated herein, the materials described in this section are not admitted to be prior art, or suggestions of the prior art, by inclusion in this section.

### SUMMARY OF THE DISCLOSURE

According to certain aspects of the disclosure, methods and systems are disclosed for predicting pet health conditions. In some embodiments, a method for predicting pet health conditions includes receiving, by at least one processor, activity data generated by at least one sensor device configured to detect activity of a pet; determining, by the at least one processor, behavior data indicative of a plurality of behaviors of the pet based on the activity data; receiving, by the at least one processor, a trained neural architecture for a representation model configured to facilitate health condition predictions and another neural architecture for a classification model configured to predict a health condition of the pet based at least in part on the behavior data; predicting, by the at least one processor using the trained neural architecture, presence of the health condition of the pet; and causing, by the at least one processor, a user device to display a notification including information identifying the health condition.

In other embodiments, a computer system for predicting pet health conditions includes at least one memory having processor-readable instructions stored therein, and at least one processor configured to access the at least one memory and execute the processor-readable instructions, which when executed by the at least one processor cause the at least one processor to perform a plurality of functions. The plurality of function include receiving activity data generated by at least one sensor device configured to detect activity of a pet, determining behavior data indicative of a plurality of behaviors of the pet based on the activity data, receiving a trained neural architecture for a representation model configured to facilitate health condition predictions and another neural architecture for a classification model configured to predict a health condition of the pet based at least in part on the behavior data, predicting, using the trained neural architecture, presence of the health condition of the pet, and causing a user device to display a notification including information identifying the health condition.

In other embodiments, a non-transitory computer-readable medium is configured to store instructions that, when executed by at least one processor of a device for predicting pet health conditions, cause the at least one processor to perform operations including receiving activity data generated by at least one sensor device configured to detect activity of a pet, determining behavior data indicative of a plurality of behaviors of the pet based on the activity data, receiving a trained neural architecture for a representation model configured to facilitate health condition predictions and another neural architecture for a classification model configured to predict a health condition of the pet based at least in part on the behavior data, predicting, using the trained neural architecture, presence of the health condition of the pet, and causing a user device to display a notification including information identifying the health condition.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram of a system for predicting pet health conditions, according to one or more embodiments of the present disclosure.

FIG. 2 depicts a graph of output signal over time for a sensor device of the system of FIG. 1.

FIG. 3 depicts a table of behavior data of a pet.

FIG. 4 depicts a diagram of a machine learning model configured for predicting pet health conditions, according to one or more embodiments.

FIG. 5 depicts a map of behavior data following a dimensionality reduction by a neural architecture generated by the machine learning model of FIG. 4.

FIG. 6 depicts a table for storing pet behavior data following a dimensionality reduction, according to one or more embodiments.

FIG. 7 depicts a receiving operating characteristic curve plot for a plurality of neural architectures generated by the machine learning model of FIG. 4.

FIG. 8 depicts a Shapley additive explanations summary plot showing relative contributions of individual input behavior to a classification model for predicting pet health conditions.

FIG. 9 depicts a map of disease prevalence for a plurality of pets.

FIG. 10 depicts an exemplary user interface of a user device, according to one or more embodiments.

FIG. 11 is a flow chart depicting an exemplary method for predicting pet health conditions, according to one or more embodiments.

FIG. 12 is a flow chart depicting an exemplary method for training a machine learning model, according to one or more embodiments.

FIG. 13 depicts an exemplary method for training a machine learning model, according to one or more embodiments.

FIG. 14A depicts an exemplary pet cyclical pattern, according to one or more embodiments.

FIG. 14B depicts an exemplary pet cyclical pattern with a cyclical pattern shape, according to one or more embodiments.

FIG. 15 depicts an exemplary computing device that may execute the techniques described herein, according to one or more embodiments.

### DETAILED DESCRIPTION OF EMBODIMENTS

According to certain aspects of the disclosure, methods and systems are disclosed for predicting pet health conditions based on pet behavior. In particular, the methods and systems described herein may use various machine learning techniques, such as dimensionality reduction or representation learning, such as the use of auto encoders as dimensionality reduction models, to generate a sequence of machine learning models for predicting pet health conditions. In some embodiments, a first model may be a dimension-reducing auto encoder neural architecture, which is selected via search of a plurality of architectures. A second model may be a machine learning model that predicts a health condition using autoencoded dimensions as key feature inputs. The second model may be comprised of a neural architecture or other machine learning classification model(s), such as tree-based classifiers or support vector machines. In some embodiments, the predictions may be utilized to diagnostically to recommend a course of action to address an identified health condition.

Typically, health conditions of a pet are first identified when a pet owner notices an appearance, mood, or behavior change in the pet. The owner may then contact a veterinarian for an examination and formal diagnosis. However, some behavioral changes indicative of a health condition may be subtle or not recognized by the pet owner, which can delay diagnosis and treatment. Moreover, pet behavior is a complicated science that, when assessed holistically, is often more than the summation of individual behaviors. For example, behaviors that are not necessarily outwardly reflective of a particular health condition may actually be indicative of such a health condition when considered in combination with other behaviors (or non-behavioral data). The relationships between all of the factors that go into a pet's behavioral profile are often too complex and voluminous for pet owners or veterinarians to appreciate when initially detecting a health condition and/or making a formal diagnosis.

Accordingly, there exists a need for methods and systems for predicting pet health conditions utilizing a multifactorial approach that considers a pet's behavioral profile holistically, rather than as discrete, individual behaviors. The methods and systems of the present disclosure address this need by applying various machine learning techniques to multifactorial pet behavior data in order to generate neural architectures for predicting health conditions. These predictions may then be used to make recommendation for seeking a medical diagnosis, further monitoring the pet, and/or initiating a treatment plan.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

As used herein, a term such as “user” or the like generally encompasses a future pet owner, future pet owners, pet owner, and/or pet owners. A term such as “pet” or the like generally encompasses a domestic animal, such as a domestic canine, feline, rabbit, ferret, horse, cow, or the like. In exemplary embodiments, “pet” may refer to a canine.

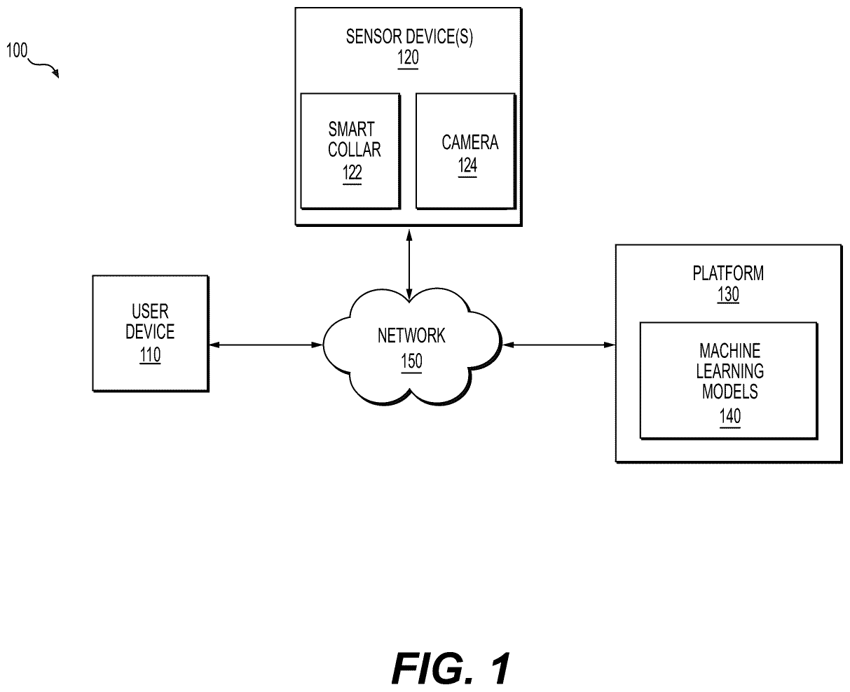

FIG. 1 is a diagram of a system 100 for predicting pet health conditions in accordance with one or more embodiments of the present disclosure. As shown in FIG. 1, the system 100 may include a user device 110, one or more sensor devices 120, a platform 130, one or more machine learning models 140, and a network 150.

The user device 110 may include a device configured to display and/or audibly present information received from the platform 130 or other component of the system 100. For example, the user device 110 may be a smartphone, a desktop computer, a tablet computer, a laptop computer, a smart speaker, a wearable device, or the like. Additionally, in some embodiments, the user device 110 may be used as an intermediary device configured to facilitate communication of data between the sensor device(s) 120 and the platform 130.

The sensor device(s) 120 may be one or more devices configured to obtain information associated with the pet. The sensor device(s) 120 may include a device and/or a sensor that may attach to a pet. For example, the sensor device(s) 120 may be a smart collar 122 configured to attach around the pet's neck, and/or a camera 124 configured to observe activity of the pet. The sensor device(s) 120 may be configured to detect a pet's physical activity, location, eating and drinking information, and the like using one or more sensors of the sensor device(s) 120. Example sensors may include accelerometers, thermometers, gyroscopes, altimeters, imaging sensors (e.g., optical cameras, infrared cameras), etc. Specific examples of physical activity that may be detected by the sensor device(s) 120 include scratching, licking, walking, lying down, sleeping, eating, drinking, and the like.

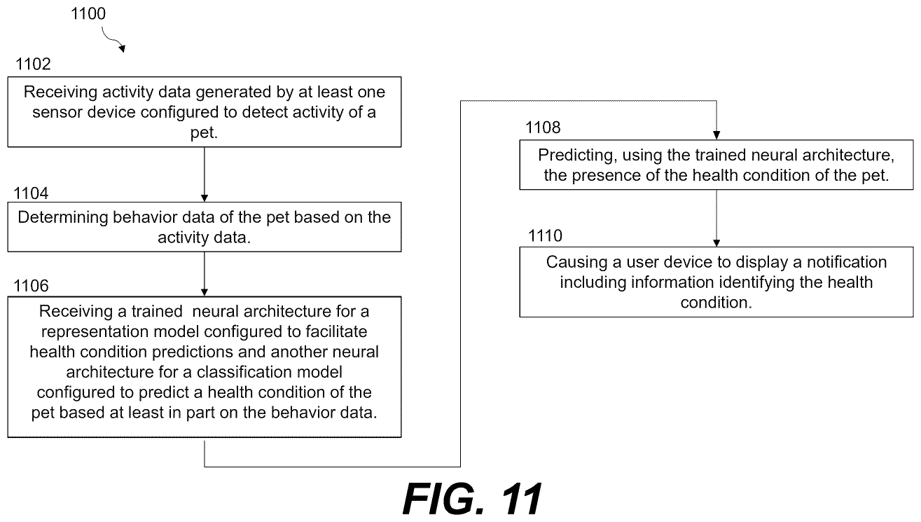

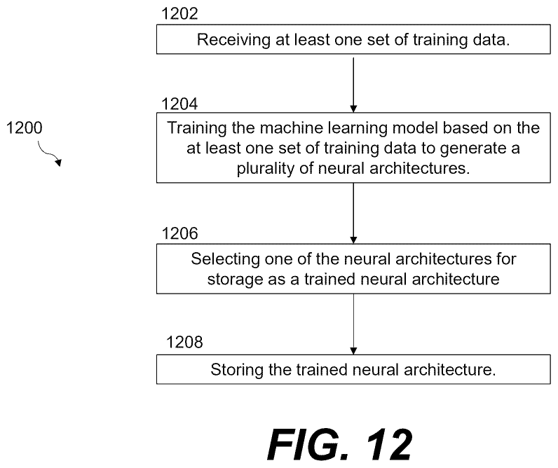

The platform 130 may be a device configured to perform operations for determining pet health conditions and/or to perform operation for other techniques presented herein. For example, the platform may include a processor configured to execute the steps of method 1100 of FIG. 11 and/or method 1200 of FIG. 12, as will be described herein. In some embodiments, the platform 130 may be a server, a cloud-computing device, or the like. The platform 130 may include and/or may be associated with one or more data storage systems.

The machine learning model(s) 140 may be one or more models configured to receive sensor data generated by the sensor device(s) 120 and determine a pre-diagnosis, diagnosis, or other prediction related to a health condition of the pet. Alternatively or additionally, the machine learning model(s) 140 may be one or more models configures to receive processed data from upstream models that receive sensor data generated by the sensor device(s) 120, such as receiving prediction of behavior from an upstream FilterNet model. In some embodiments, the machine learning model 140 may include a representation training model and/or an autoencoder, though other types of neural networks may be used additionally or alternatively to an autoencoder. The machine learning model 140 may be trained using a training technique and training data, as described in greater detail herein with respect to the method 1200 of FIG. 12. The platform 130 may store the trained machine learning model 140 in one of the data storage systems of and/or associated with the platform 130, and use the trained machine learning model 140 to determine a pre-diagnosis, diagnosis, or other prediction related to a health condition of the pet based on data received from sensor device(s). As used herein, the term “pre-diagnosis” means a determination that a health condition may potentially be present, but other diagnostic techniques are need to confirm such diagnosis. Additionally, or alternatively, the platform 130 (or another device) may provide the trained machine learning model 140 to the user device 110 to permit the user device 110 to use the trained machine learning model 140.

The network 150 may be a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) of the system 100 may perform one or more functions described as being performed by another set of components of the system 100.

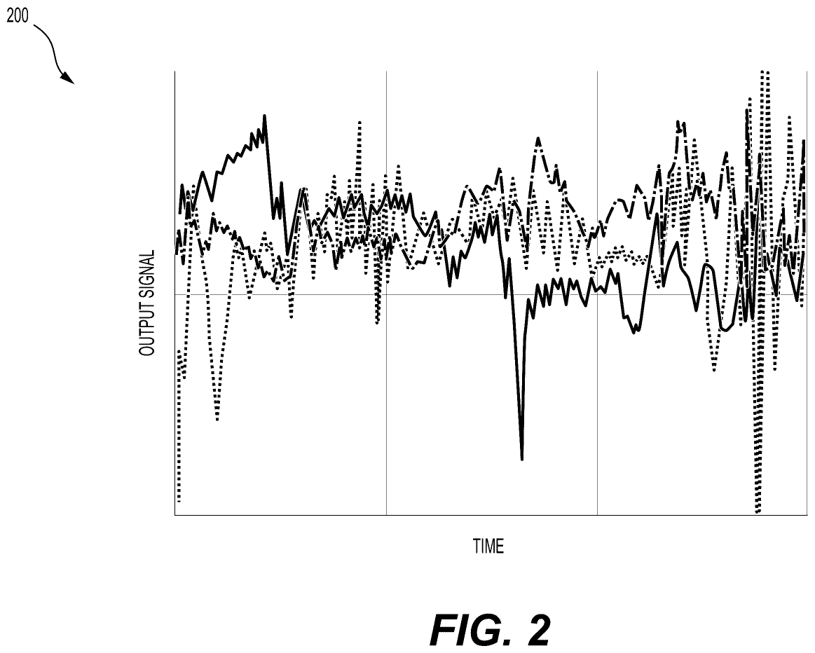

FIG. 2 depicts a graph 200 of exemplary accelerometer (or other sensor) output data generated by the smart collar 122 of FIG. 1. The graph 200 illustrates time on the horizontal axis, and output signal on the vertical axis. The output signal may be, for example, an output voltage. In general, the output signal from the accelerometer (or other sensor) changes as the smart collar 122 experiences motion due to movement of the pet. The output signal may be converted into pet behaviors using various methods. For example, the output signal may be converted into pet behavior using a machine learning model, such as the machine learning model 140 of FIG. 1. The machine learning model (which may be a FilterNet model) may be trained on sensor data that is labeled via data gathered from the camera 124 of FIG. 1 by correlating the time stamps of image data received from the camera 124, and then labeled with target behaviors, to time stamps of the output signal of the accelerometer (or other sensor). Thus, the machine learning model may be trained to determine specific activity, e.g. scratching, based on the output signal (and/or patterns in the output signal) from the accelerometer (or other sensor).

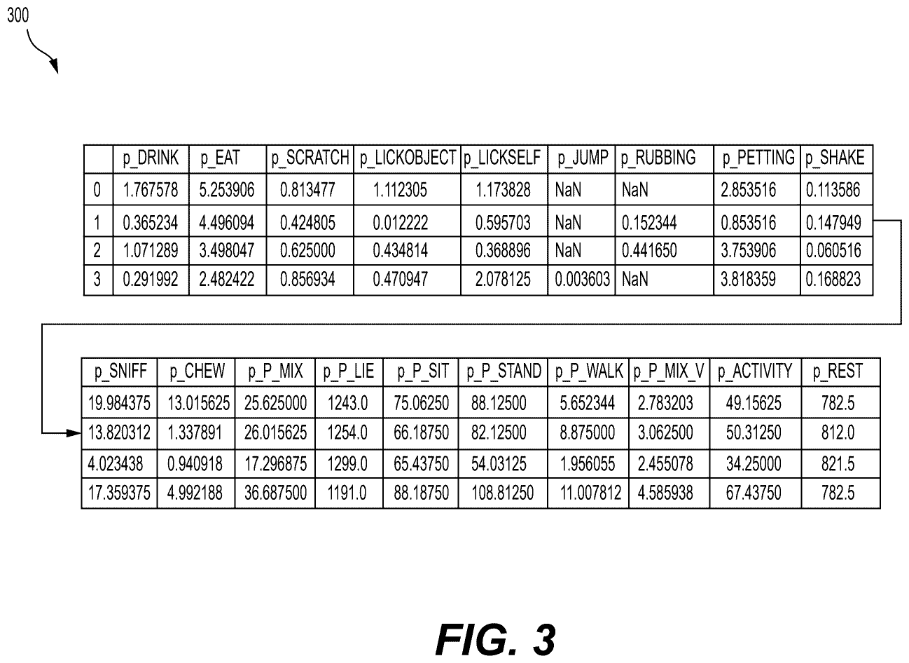

FIG. 3 depicts a table 300 of behavior data, which may be based on the activity data collected by the sensing device(s) 120 of FIG. 1. Each row of the table 300 corresponds to a time interval, for example a day in the life of a pet. Thus, table 300 includes data for four days in the life of the pet, corresponding to rows 0, 1, 2, and 3. Each column of the table 300 represents a particular behavior of the pet, such as drinking, eating, scratching, etc. The values populating the table 300 correspond to the probable amount of time, in minutes, that the pet engaged in the associated activity on a particular day. The probable amount of time may be determined using the output signal from the accelerometer of the smart collar 122, as discussed in connection with FIGS. 1 and 2. For example, a machine learning model may be utilized to determine, to a predetermined degree of certainty, how much time on a given day the pet engaged in each activity of the table 300 based on the accelerometer output signals. For example, the first column of the table 300, labeled “p_DRINK” indicates the probable amount of time the pet spent drinking. On Day 0 (the first row of the table 300), the pet spent 1.767578 minutes drinking; on Day 1, the pet spent 0.365234 minutes drinking, etc. An entry of “NaN” (Not a Number) in the table 300 indicates that probability data was not received and/or could not be determined with respect to the associated behavior.

As will be described herein, the values of the table 300 (i.e., the time that a pet spends engaging in various behaviors) may be utilized to train one or more machine learning models (e.g., the trained machine learning model 140 of FIG. 1) to determine a pre-diagnosis, diagnosis, or other prediction related to a health condition of a pet. In particular, the machine learning model may utilize all or a subset of the behaviors represented in the table 300 to make such a determination. A total of nineteen behaviors are represented in the table 300, though more or less behaviors may be used in alternate embodiments. There is no significant limitation to how many behaviors are represented in the table 300.

In some embodiments, the nineteen columns in the table 300 may further be doubled into 38 columns, with each behavior having a column for each of mean and standard deviation of time spent performing the associated behavior. For example, the behavior “drinking” may be associated with two values, a first value being a mean (or average) time that the pet spent drinking on a corresponding day, and a second value being a standard deviation that the time that the pet spent drinking on the corresponding day. In some embodiments, the mean and standard deviation values are calculated over aggregates taken each minutes (i.e. a total of 1,440 aggregates each day, or another predetermined and/or dynamic number of aggregates). In some embodiments, metric aggregates describing behaviors will be represented by higher dimensional tensors. For example, time-windowed behavior aggregates from each dog could be represented as a single row, as in FIG. 3, or by series of rows in a 2D tensor where each row represents a time segment within the series, such as successive days, hours, or minutes.

In embodiments in which the machine learning techniques of the present disclosure are used to predict the presence of a health condition (e.g. an ear infection, renal infection, a dermatological disease, a weight-associated disease, a musculoskeletal disease, arthritis, etc.) the number of columns in the table 300 may be further increased to separate data collected prior to the health condition being present and data collected during the presence of the health condition. For example, data collected up to seven days prior to a diagnosis of the health condition may be considered as indicative of behavior when the health condition was present, whereas data collected more than 14 days prior to diagnosis of the health condition may be considered indicative of behavior when the pet was healthy (i.e. the health condition was absent). These time windows are exemplary for predicting an ear infection and may vary based on the targeted health condition.

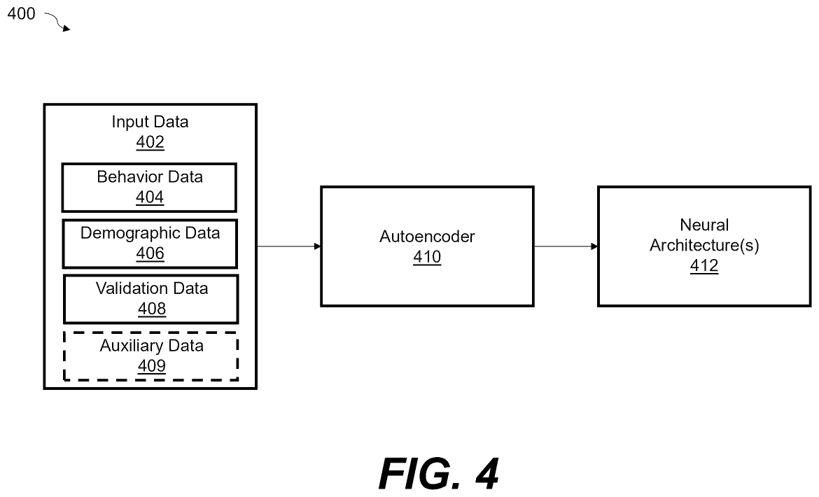

FIG. 4 depicts an exemplary diagram for a machine learning model 400 (e.g., the machine learning model 140 of FIG. 1), in accordance with embodiments of the present disclosure. The machine learning model 400 includes a representation model (e.g., an autoencoder) 410 configured to receive input data 402, such as behavior data 404, demographic data 406, cohort data 408, and auxiliary data 409. Note that the terms representation model and autoencoder may be used interchangeably throughout this disclosure. It is to be understood that recitations of an autoencoder should be broadly construed to include other forms of representation models. Similarly, in the chain of two models, the representation model or autoencoder (410) is a neural architecture. For the second model (412), any neural architectures can be used, but in one embodiment, other types of classification models (such as a tree-based classifiers), may be used to classify whether a pet has the health condition or not. The behavior data 404 may include the data sets for a plurality of pets, each dataset akin to the table 300 of FIG. 3 (which represents behavior data for a single pet). For example, the behavior data 404 may include tables of behavior data respectively associated with hundreds or thousands of pets.

The demographic data 406 may include information related to the gender, weight, height, and/or breed of each pet represented in the behavior data 404. In some embodiments, the demographic data 406 may be provided by the owner of the pet(s), for example via the user device 110 of FIG. 1. In some embodiments, the demographic data 406 may be collected from alternative or additional sources, such as veterinary or medical records associated with each pet.

The cohort data 408 may include information related to the pet health condition for which the autoencoder 410 is evaluated. That is, the autoencoder 410 may be trained on the behavior data and then, post-training, evaluated using the cohort data 408. For example, the autoencoder 410 could be trained to learn latent features from behavior data, where these learned embeddings promote successful downstream training of an ear infection pre-diagnosis model. In such a case, the cohort data 408 includes a binary value for each pet represented in the behavioral data 404 indicating whether the behavior data 404 associated with that pet was collected during an active ear infection. For example, if the pet represented by the behavior data of the table 300 is experiencing an ear infection during the time of data collection (i.e. Day 0 to Day 3 of the table 300), the cohort data 408 includes a positive value for the pet associated with the table 300. Similarly, if the pet associated with the table 300 was not experiencing an ear infection during the time of data collection, the cohort data 408 includes a negative value. Additionally or alternatively, a pet may be assigned a negative value based on insight from medical records (or other means) confirming that the dog did not have an ear infection. For example, the medical records may indicate a veterinary examination where a diagnosis of an ear infection was not indicated (i.e., the pet does not have an ear infection). In some embodiments, the cohort data 408 may be provided by the owner of the pet(s), for example via the user device 110 of FIG. 1. In some embodiments, the cohort data 408 may be collected from alternative or additional sources, such as veterinary or medical records associated with each pet. In some embodiments, cohort may be indicated from sensor devices 120, possibly with associated machine learning models to conduct cohort assignment.

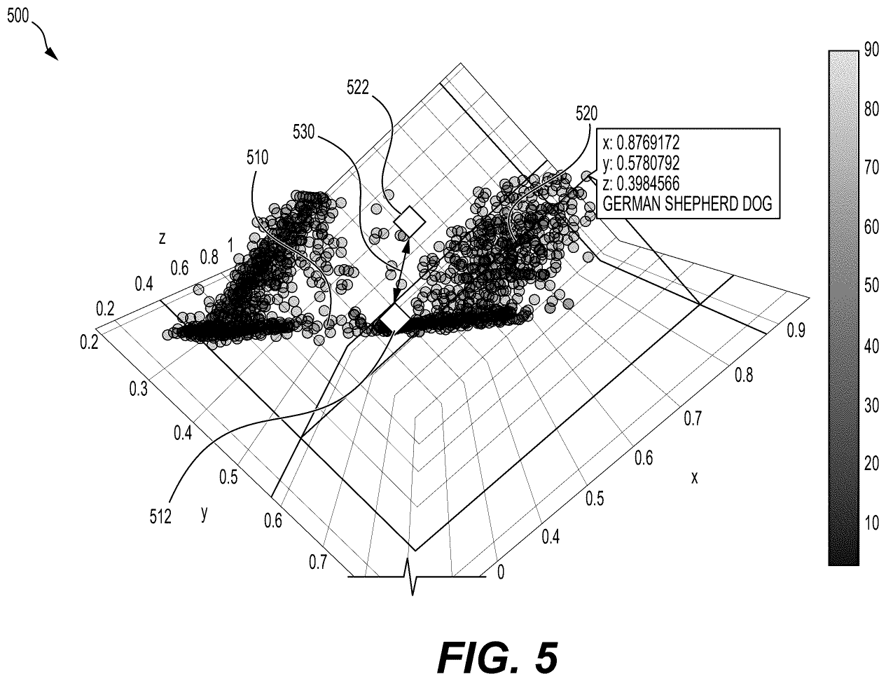

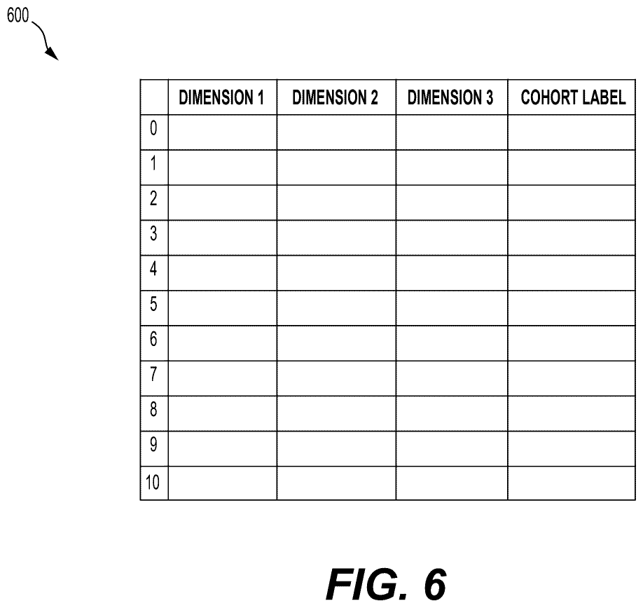

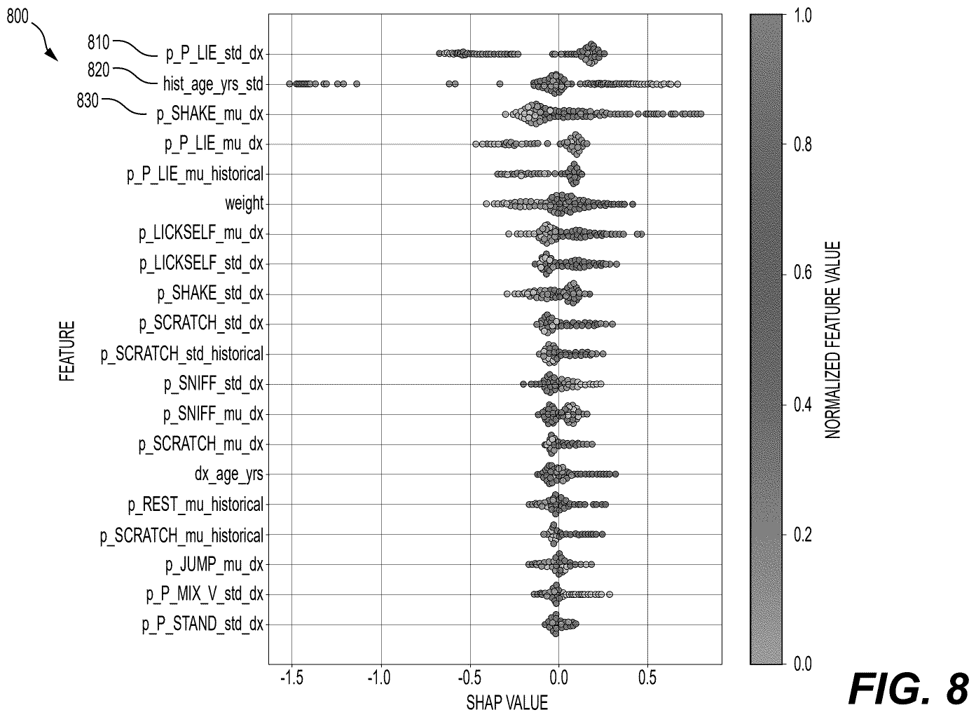

The auxiliary data 409 may include various data collected from other sources. In some embodiments, the auxiliary data 409 may include data collected from the process of training the machine learning model 400, as will be discussed below with reference to FIGS. 5 and 6. In some embodiments, the auxiliary data 409 could include genetic or diagnostic information about the pet, or other health-related data. In some embodiments, the auxiliary data 409 may include data from other machine learning models, as will be discussed below with reference to FIG. 8. In some embodiments, no auxiliary data 409 is used.

The machine learning model 400 may be flexible in that additional data can be readily incorporated into the input data 402 by simple column-wise concatenation. That is, the demographic data 406 and/or the auxiliary data 409 can be concatenated to the behavior data 404 to increase the dimensionality of the data provided to the autoencoder 410. For example, the nineteen columns of table 300, constituting the behavior data 404, can be concatenated with three columns constituting the demographic data 406 (e.g., gender, weight, and height) for a total of 22 columns (i.e. dimensions) of the input data 402. The auxiliary data 409, if used, can be concatenated in a similar manner.

The autoencoder or other representational model 410 is configured to be either a single or plurality of neural architectures that map the input data 402 to an embedding vector space. The representation model 410 may be further configured to evaluate each generated neural architecture among the plurality of architectures using one or more evaluation metrics, as will be discussed herein. In some embodiments, the representation model 410 may perform a dimensionality reduction on the input data 402. For example, the input data 402 may include nineteen dimensions corresponding to the behavior data (i.e., the nineteen behaviors represented in the columns of the table 300), and three dimensions corresponding to the demographic data 406 (i.e., gender, height, and weight). The autoencoder 410 may perform a dimensionality reduction to generate a latent space embedding having three dimensions, five dimensions, etc. These latent space embeddings are then used as feature input data for the neural architecture(s) 412, which are trained to classify the target health condition by providing cohort labels as predictive targets for model training. For example, the cohort labels may correspond to the behavior labels (described below), where the cohort labels may correspond to whether the pet has a health condition and/or the degree of severity of the health condition (e.g., Body Conditioning Score of “3”). In some embodiments, the latent space embeddings may be further transformed or processed prior to being leveraged as predictive features in model 412. For example, if each embedding from the representation model 410 represents one day of behavior from one dog, several embeddings from one dog might be aggregated, or similarly processed, to obtain, for example, averaged embedding coordinates that represent typical daily behavior within a week(s) or month(s).

FIG. 5 depicts an exemplary three dimensional map 500 of dimensionally reduced behavior data generated by one of the neural architectures 410 of FIG. 4. In the illustrated embodiment, the neural network is configured to predict weight of a pet based on the input data 402 (which in some embodiments may not include the demographic data 406). The cohort data 408 includes the known weight of the pets associated with the input data 402, and is used to evaluate the neural architecture 412. The neural architecture 412 is configured to make a binary determination of weight, i.e. whether a pet is “high weight” or “low weight”. “High weight” and “low weight” may be arbitrary categorizations determined prior to training neural architecture 412. For example, “high weight” may correspond to a weight of 70-100 pounds, whereas of “low weight” may correspond to a weight of 0-30 pounds. The autoencoder 410 performs a dimensionality reduction on the input data 402 from the nineteen dimensions corresponding to the number of behaviors (e.g., the number of behaviors from the table 300) to three dimensions which can be plotted on the 3D map 500. That is, the nineteen dimensions of the table 300 that form the behavior data 404 (and, in some embodiments, additional dimensions of the demographic data 406 and, in some embodiments, additional auxiliary data 409) are blended to reduce the number of dimensions to three. Different neural architectures 410 may blend the nineteen (or more, when demographic or auxiliary data is included) dimensions in different ways, and to differing latent space dimensionality (including 3D as in FIG. 5), resulting in varying effectiveness among the generated neural architectures 412, where effectiveness is defined by high performance in predictive measures for (in this example case) predicting whether a dog is high weight or low weight.

As an unsupervised machine learning approach, the representation model (410) can be trained on more pet behavior histories beyond the pets for which cohort data (408) labels are available. However, in some embodiments, only pets with cohort labels are used in the classification model (412). Thus, the representation model (410) is able to learn statistical distributions from a larger quantity of input data (402) than is available within the cohort data alone, and this learning is imparted to the latent space embeddings used as features for classification model 412.

The result of the dimensionality reduction performed by the autoencoder 410 for one of the neural architectures is plotted to the map 500. Each data point on the map 500 may represent aggregate data for all dimensions of one time interval of the behavior data 404. In the illustrated example, each data point on map 500 corresponds to aggregate data from each of the nineteen dimensions for 30 days (i.e., 30 rows of the data from the table 300, which are aggregated to form a mean). Thus, each data point in the three-dimensional plot, as defined by the x, y, and z coordinates of the map 500, may be derived from nineteen dimensions and 30 rows of table 300. In other embodiments, data may not be aggregated, and each data point on the map 500 represents a single row from the table 300. The use of aggregation may depend on various factors including the particular use case of the machine learning model(s).

The validation data 408, in the case highlighted in FIG. 5, is used to create cohort labels from the known weight of each pet respectively associated with each data point. The pet weight is used to divide the data into two cohorts, a first cohort for pets which are known to be “low weight” based on the data 408, and a second cohort for pets which are known to be “high weight” based on the data 408. In the illustrated example, the data points on the map associated with pets in the first cohort (i.e. pets known to have a low weight based on the cohort data 408) are clustered near a first region 510, whereas the data points associated with pets in the second cluster (i.e. pets known to have a high weight based on the cohort data 408) are located farther away from the first region 510 in a second region 520. The graphical distinction between the regions 510, 520 is due to the employed neural architecture 410 being relatively effective, as will be described below. However, for less effective neural architectures, the data points between the cohorts may not show such significant clustering about the regions 510, 520, nor effective distance separation 530 from cluster centers.

The effectiveness of the neural architecture 412 may be evaluated using one or more evaluation metrics. For example, one evaluation metric may be a vector distance 530 between a centroid 512 of the data from the first cohort of pets, and a centroid 522 of the data from the second cohort of pets. That is, the centroid 512 may be the arithmetic average of the embedding space coordinates of all data points associated with pets known to have a low weight, and the centroid 522 may be the arithmetic average of the embedding space coordinates of all data points associated with pets known to have a high weight. A neural architecture which produces a greater vector distance 530 between centroids 512, 522 is more effective at distinguishing between pets of the two cohorts (here, low weight and high weight) and is therefore a more effective neural architecture.

Other evaluation metrics may also be employed to suit particular types of data and/or use cases. In some embodiments, a binary classifier (412) may be trained on the embedded data, and any of its performance metrics (accuracy, f1, etc.) could be used to represent the effectiveness of the autoencoder (410). In such embodiments, the representation model 410 can serve as a feature engineering model that enhances signal over noise from input data 402 to improve predictive performance of neural architecture(s) 412. In other embodiments, a clustering model (k-means, DBSCAN, GMM, etc.), trained to identify clusters in the embedding space of model 410, could be trained on the embedded points representing the two cohorts. In other embodiments, an intrinsic (e.g., Silhouette Score, Calinski-Harabasz Index, etc.) or extrinsic (V-measure, Mutual Information, etc.) clustering measure could be used as a proxy for autoencoder effectiveness. As noted above, the particular evaluation metric(s) utilized will be determined by the type a data and/or specific use case of the model(s) in order to provide the most effective results.

The map 500 represents the results of just one representation model neural architecture 410 of FIG. 4. The autoencoder 410 may include a plurality of dozens, hundreds, or thousands (or more) of different generated neural architectures that have various degrees of effectiveness relative to the results shown in the map 500, as evaluated using the evaluation metric(s) (e.g., the vector distance between centroids). The most desirable (e.g., most effective based on one or more evaluation metrics) neural architecture generated by the autoencoder 410 may be stored for use with future pre-diagnostic, diagnostic, and/or other predictive purposes, as discussed below. Similarly, the predictive model 412 may include a plurality of predictive models, possibly composed of a population of different neural architectures or possibly composed of a population of other machine learning model types (such as tree-based classifiers) defined by diverse hyper parameters; and these models can have various degrees of effectiveness in predicting a health condition of a pet.

As described above, the map 500 illustrates a map of pet behavior (e.g., input data 402) that has been optimized to separate dogs by weight while still representing the input data in the embedded space. Thus, weight is the target feature of the machine learning model 400 with respect to the map 500. In other embodiments, the target feature can be any binary or non-binary health-related condition of a pet. In some embodiments, the machine learning model 400 may be used to train neural architecture(s) 412 for predicting the presence of an ear infection, renal infection, a dermatological disease, a weight-associated disease, a musculoskeletal disease, arthritis, etc. In such embodiments, the cohorts used as the basis for evaluation of the neural architecture(s) 412 are a first cohort including pets known to have the health condition, and a second cohort including pets known to not have the health condition. The types of health conditions that the neural architecture(s) 412 can be configured to determine is limited only by the availability of the cohort data 408 (e.g., the data from veterinary/medical records, or feedback from owners, establishing the presence or absence of a health condition in the pets) necessary to evaluate the effectiveness of the generated neural architecture(s) 412.

In some embodiments, the data generated by the neural architecture(s) 410 of FIG. 4 may be labeled by the cohort groups for subsequent training or inference by model(s) 412. FIG. 6 shows an exemplary table 600 for storing the data after the dimensionality reduction performed by the neural architecture(s) 412. Each cell in the table 600 corresponds to one of the data points on the map 500. As with the table 300 of FIG. 3, each row of the table 600 corresponds to predetermined time interval of data collection, e.g., one day. Table 600 includes a number of columns equal to the number of dimensions of the map 500. Table 600 includes three columns (“Dimension 1”, “Dimension 2”, and “Dimension 3”) which respectively correspond to one dimension of each data point on the map 500, and a fourth column (“Label”) corresponding to the cohort of the data point.

In some embodiments, the data from the table 600 may be used as the auxiliary data 409 of FIG. 4 during subsequent iterations of the machine learning model 400 to improve the neural architecture(s) 412.

While the table 600 of FIG. 6 has been described with respect to a particular embodiment for predicting weight of the pet, it should be understood that the table 600 would be similarly implemented for prediction of other health conditions. For example, in an embodiment for predicting the presence of an ear infection, renal infection, a dermatological disease, a weight-associated disease, a musculoskeletal disease, arthritis, etc., the first cohort of the table 600 may correspond to data collected when the pet(s) are healthy, and the second cohort of the table 600 may correspond to data collected when the pet(s) have the health condition. For example, the first cohort may include data collected at least 14 days prior to the pet being diagnosed with the health condition so as to be reflective of behavior when the pet is healthy. Conversely, the second cohort may include data collected up to seven days prior to a positive diagnosis of the health condition, so as to be reflective of behavior when the pet has the health condition. This data could be directly used as training data into a version of model 412 that accommodates time series inputs, such as recurrent-architecture-based-or convolutional-architecture-based-neural networks, and which could be trained as binary or multi-class classifiers based on the time series input data. Alternatively, the data in table 600 could be further transformed in intermediate data engineering steps, such as aggregating data per dog by averaging over 7 days prior to the diagnosis or control dates, or averaging data over all days 14 days or longer before the diagnosis of control dates. In such an embodiment, each row of table 600 is converted from representing a dog-day to representing a dog (where the values in the row represent an aggregation over dog-days). After such a transformation, the data is suitable for input as training and test data into model(s) 412, possibly including a variety of neural architectures, and possibly including a variety of conventional binary classification models, such as tree-based models (such as Random Forest or XGBoost models), logistic regression models, or support vector machine-based models.

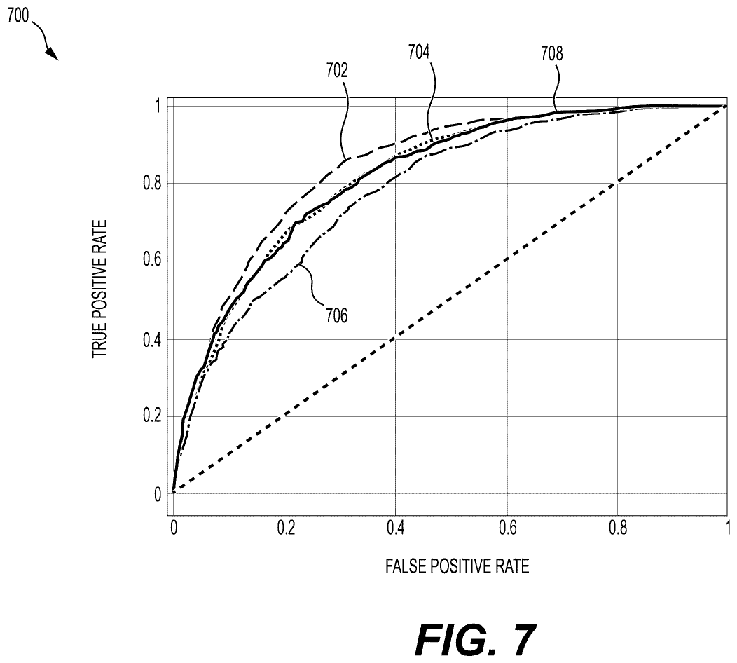

Referring now to FIG. 7, an exemplary plot 700 of receiver operating characteristic (ROC) curves is shown for a plurality of classification models 412 (here, XGBoost binary classifiers) for predicting the presence a health condition, such as ear infection. The ROC curves can be used to evaluate the relative effectiveness of the associated neural architectures. As illustrated, the plot 700 of ROC curves is a graphical representation of false positive rate (shown on the x axis) relative to true positive rate (shown on the y axis). The true positive rate corresponds to a rate at which a neural architecture correctly identifies the presence of a health condition (e.g., an ear infection) in the training data, and the false positive rate corresponds to a rate at which a neural architecture identifies a health condition (e.g. an ear infection) that is not actually present in the training data. The illustrated plot 700 particularly includes three ROC curves 702, 704, 706 each associated with a respective pair of representation model (410) and classification model (412) of FIG. 4, as described above. Further, the ROC curve plot 700 includes a fourth curve 708 associated with a machine learning model for which dimensionality reduction was not performed. That is, curve 708 is representative of a machine learning architecture in which all dimensions (e.g., all nineteen dimensions of the table 300) are utilized without blending. The curves 702, 704, 706, 708 are overlaid on the same plot 700 so that the relative effectiveness of the associated machine learning architectures can be evaluated.

Of the curves 702, 704, 706, 708 illustrated in the plot 700, the curve 702 consistently demonstrates the highest rate of true positive detection, indicating that the autoencoder 410-classifier 412 pair associated with the curve 702 is the most effective machine learning model combination, including the most effective autoencoder neural architecture, based on the training data, among the set of 5 predictors evaluated in FIG. 7. Thus, neural architecture 412 associated with the curve 702 may be stored for use in future pre-diagnostic, diagnostic, or other predictive assessments of a pet, as described below.

Again, it is to be understood curve 702 is illustrative and represents only one potential model based on a particular example of Bayesian optimization of autoencoder architectures. Additional, possibly more effective, models may be found with additional evaluation using a variety of approaches to neural architecture search, neural architecture optimization, etc.

As indicated above, the curve 708 is representative of a machine learning architecture in which a dimensionality reduction is not performed, in contrast to the classification model 412, which was trained on dimensionally reduced data output from the autoencoder 410. The curve 708 may be significant, particularly when the curve 708 demonstrates a relatively high effectiveness, because the lack of dimensionality reduction allows each of the dimensions of the input data 402 of the machine learning model 400 to be individually assessed for effectiveness. That is, the behaviors associated with each of the nineteen columns of the table 300 of FIG. 3 forming the behavior data 404 can be assessed to determine each behavior's individual contribution to the machine learning model underlying the curve 708. Similarly, each factor of the demographic data 406 (e.g., height, weight, and gender) can be assessed to determine each behavior's individual contribution to the machine learning model underlying the curve 708.

FIG. 8 depicts a Shapley additive explanations (“SHAP”) summary plot 800 showing the relative contribution of each input behavior to the architecture underlying the curve 708 of FIG. 7. Each line of the plot 800 corresponds to one dimension of the input data 402 of FIG. 4 including both the behavior data 404 and the demographic data 406. In the embodiment represented in FIG. 8 and curve 708 of FIG. 7, behavior data 404 was subject to feature engineer to obtain means and standard deviations of behaviors across different time-windows that were either far from (e.g., >14 days before) or close to (e.g., <7 days before) vet visits from which a cohort labels were obtained. This led to 79 features of behavior data that were used as training and inference inputs for the ear infection classification model associated with curve 708. In other embodiments, similar or alternate feature engineering approaches on the behavior data may be utilized, according to the particular use case or health condition targeted.

The plot of FIG. 8 represents a SHAP plot showing the top 20 most important features (though all 79 features were ranked for importance). Tags on the features indicate what type of aggregation (“mu” for mean or “std” for standard deviation) on which aggregation time window (“dx” indicating the window close to the vet visit, or “historical” indicating the window far from the vet visit) led to the feature.

The lines of the plot 800 are arranged in order of descending importance to the underlying classification model. As shown in the plot 800, the three most predictive dimensions of the health condition (e.g. ear infection) associated with the curve 708 are the standard deviation of lying down behavior close to the vet visit 810, age of the pet 820, and mean of shaking behavior close to the vet visit 830. In some embodiments, the individual contributions of the various behavior and/or demographic dimensions on the machine learning model can be input into the autoencoder 410 of FIG. 4 as the auxiliary data 409 during further iterations of generating the neural architectures 412. As such, the generated classification models 412 may be improved based on the knowledge of which behaviors are more and less relevant to determination of the presence of the health condition (e.g. ear infection) being trained for. In particular, representation models 410 and classification models 412 may be trained to emphasize data related to behaviors that are most predictive, and deemphasize data related to behaviors that are less predictive.

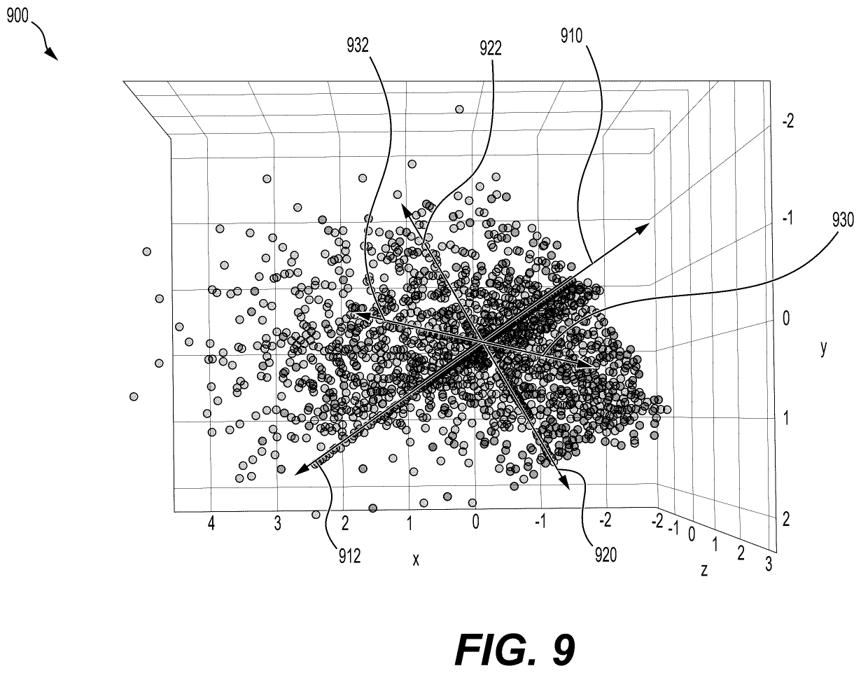

FIG. 9 depicts a map 900 of disease diagnoses for a plurality of pets that may, in some embodiments, be used as the auxiliary data 409 by the machine learning model 400 of FIG. 4. The map 900 particularly indicates the prevalence and number of various diseases in pets. Based on sampled pets, the approximate origin of the point-cloud's implicit coordinate system falls between “young” pets less than six years old and “old” pets greater than six years old. The map 900 may be generated by a machine learning model, which may utilize a dimensionality reduction technique such as principal components analysis (PCA). In the illustrated example of the map 900, the underlying machine learning model performed a dimensionality reduction to reduce input data for the age-of-first-diagnosis for nine individual diagnoses to three principal component dimensions representing the combination of initial diagnosis ages across nine categories. The input diagnosis categories considered are dermatological disease diagnosis, ear disease diagnosis, renal disease diagnosis, diabetes diagnosis, overweight diagnosis, bone fracture diagnosis, lameness diagnosis, arthritis diagnosis, and other musculoskeletal condition diagnosis.

The map 900 shows a plot of the obtained three principal components (x=Principal Component 1, y=Principal Component 2, z=Principal Component 3) after training the PCA model on age-of-first-diagnosis data for ˜70,000 dogs. The point-cloud resulting from this dimensionality reduction is characterized by an implicit structure that resembles an internal coordinate system. This internal coordinate system is comprised of three axes, each of which represents common health diagnoses that may occur independently of each other for many dogs. The three axes form an approximate origin point that represents middle-age (“mid-age”; this is a population average) of the analyzed dogs. Each of the three axes can thus be considered as having two sections, a section representing young ages-of-first-diagnoses, on one side of the mid-age origin, and a section representing old ages-of-first-diagnoses, on the other side of the mid-age origin. Axis section 910 represents the presence of either a dermatological condition or an ear infection in young pets. A second axis section 912 represents the presence of a dermatological disease or ear infection in old pets. Sections 910 and 912 are collinear and together form a dermatological-or-ear-condition axis, which is one of the three axes of the coordinate system implicit to the age-of-first-diagnosis point cloud. A second axis is formed from sections 920 and 922 and represents the presence of an overweight condition (e.g., a diagnosis or note in the medical records). Section 920 represents pets that received a first overweight diagnosis at a young age, with no other health diagnoses on record, and section 922 represents pets that received a first overweight diagnosis at an older age, with no other health diagnoses on record. Sections 920 and 922 are collinear and together form an overweight-condition axis, which is one of the three axes of the coordinate system implicit to the age-of-first-diagnosis point cloud. A third axis is formed from sections 930 and 932. Section 930 represents pets that received a first musculoskeletal, arthritic, lameness, or bone fracture diagnosis at a young age, with no other health diagnoses on record, and section 932 represents pets that received a first musculoskeletal, arthritic, lame, or fracture diagnosis at an older age, with no other health diagnoses on record. Sections 930 and 932 are collinear and together form a mobility-condition axis, which is one of the three axes of the coordinate system implicit to the age-of-first-diagnosis point cloud.

The three axes formed by the point cloud in FIG. 9 represent health conditions that are common and may occur independently of each other. For example, among a sample of approximately 70,000 dogs analyzed, 77% had a dermatological diagnosis and 44% had an ear infection diagnosis in their medical histories; 52% had an overweight diagnosis in their medical histories; and 45% had a musculoskeletal diagnosis, 22% had a lame diagnosis, 12% had an arthritis diagnosis, and 1% had a bone fracture diagnosis. Each of the three axes of map 900 occurs because there is a substantial population of pets that have only a specific diagnosis or combination of diagnoses (dermatological-or-ear, overweight, or mobility-related diagnoses) and no other diagnoses in their medical histories, and for each of the three diagnosis sets, the age-of-first-diagnosis varies across the population from younger dogs to older dogs.

Each data point on the map 900 corresponds to disease history of one pet for which medical data is available. For example, a data point for a young pet whose only disease history includes a dermatological disease would fall on the first axis 910. A data point for a young pet whose only disease history includes a dermatological disease and a musculoskeletal disease would fall on a plane defined by the first axis 910 and the fifth axis 930. A data point for an old pet whose disease history includes a dermatological disease, an overweight-associated disease, and a musculoskeletal disease would fall at a point between axis sections 912, 922, and 932. Some rare conditions, such as renal conditions, are not represented in the point cloud by their own axis, but the presence of such a diagnosis will move the point representing the diagnosed dog away from the 3 main axes (because that dog will not have only one of the most common diagnosis sets in its medical history, but also the rare condition, which introduces distance from the common diagnosis axes).

Based on the data displayed in the map 900, various correlations between the age, presence of disease, and co-presence of multiple diseases can be determined. For example, the data presented in the map 900 generally indicates that young pets commonly have both a dermatological disease and a musculoskeletal disease, indicated by the relatively high density of data points on the plane defined by the axis section 910 and the axis section 930. Whereas it is common for younger pets to receive only one or two diagnoses at a young age (indicated by higher density in axis sections 910, 920, and 930 and the three planes formed by them), older pets more commonly have greater than two diagnoses (indicated by lower density in axis sections 912, 922, 932, lower density in the planes formed by them, and higher density in the space between those axis sections and the planes formed by them).

The data illustrated in the map 900 may be used as the auxiliary data 409 in the machine learning model 400 of FIG. 4 to improve training of the neural architectures 412. For example, the data representing the PCA coordinates (x, y, and z) illustrated in the map 900 may be concatenated column-wise to the behavior data 404, as described above, for processing by the autoencoder 410. While the point cloud shown in FIG. 9 was generated using age-of-first-diagnosis across nine diagnosis categories, in some embodiments alternate representations of medical histories can be captured in the map 900. For example, more diagnosis conditions can be used in the input data, or age-of-most-recent-diagnosis could be used as the input data. In some embodiments, all ages of all diagnoses might be used as input data, and dimensionality reduction might be conducted with alternate ML models, such as convolutional autoencoders instead of PCA. In some embodiments, additional categories of data from veterinary medical records could be similarly represented via dimensionality reduction, such as representing a dog's history of diagnostic test results in a reduced dimensional space. If genetics data is available, that data might also be represented as coordinates in a dimensionally reduced embedding space and used as additional auxiliary data 409.

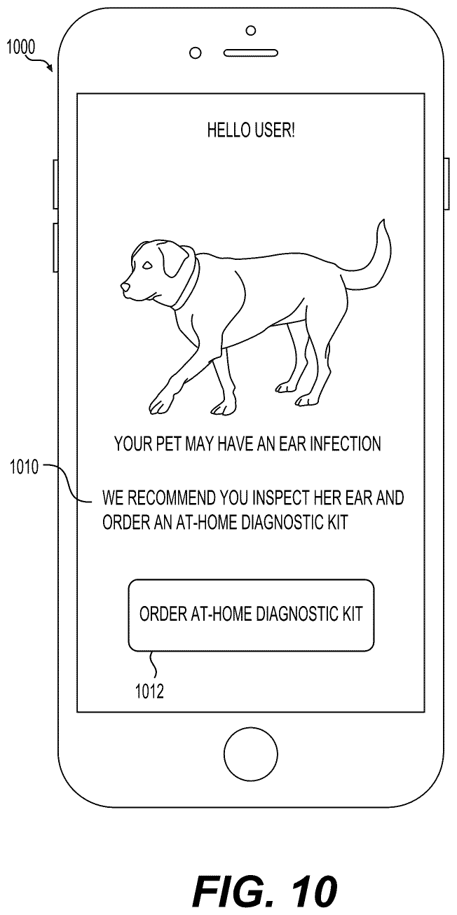

FIG. 10 depicts an exemplary user interface 1000 displayed on a user device (e.g., the user device 110 of FIG. 1), depicted as a smart phone in the illustrated embodiment. The user interface 1000 may include a notification 1010 providing pet health-related information to the user of the user device. For example, the notification 1010 may include a message indicating that the pet may have a health condition (e.g., an ear infection in the illustrated example), based on a prediction made by a machine learning model (e.g., the machine learning model 140 of FIG. 1 and/or the machine learning model 400 of FIG. 4). The message of the notification 1010 may further include a recommendation for a course of action, such as observing the pet, administering an at-home test kit for diagnosing the health condition, and/or visiting a veterinarian. In some embodiments, the notification 1010 may further include one or more control elements 1012, e.g. button(s), to allow the user to purchase an at-home test kit, schedule an appointment with a veterinarian, or take other action related to the health condition.

FIG. 11 illustrates an exemplary method 1100 for predicting pet health conditions according to embodiments of the present disclosure. Each of steps 1102-1110 of the method 1100 may be performed by at least one processor of the system 100 of FIG. 1, such as at least one processor associated with the platform 130. The method 1100 may include, at step 1102, receiving activity data generated by at least one sensor device configured to detect activity of a pet. The activity data may include, for example, the output signal (e.g., output voltage) of an accelerometer (see FIG. 2) associated with the smart collar 122 of FIG. 1.

The method 1100 may further include, at step 1104, determining behavior data of the pet based on the activity data. In some embodiments, determining the behavior data may include time-synchronizing the activity data with video from a camera (e.g., the camera 124 of FIG. 1) so that the behaviors observed by the camera can be correlated to the activity data. A machine learning model, e.g. the machine learning model 140 of FIG. 1, may be trained to identify the behavior of the pet based on the video from the camera. The behavior data may include data indicative of a plurality of behaviors of the pet, such as drinking, eating, scratching, licking objects, self-licking, jumping, rubbing, being petted, shaking, sniffing, chewing, P_Mix (a mix of behaviors such as moving a few steps and sniffing the air, which is difficult to label as a single behavior), lying down, sitting, standing, walking, P_Mix_V (a combination of behaviors performed at a vigorous pace), activity (miscellaneous or other activity), and resting. The behaviors can be many and varied, depending on the details of the sensor devices(s) 120 and machine learning model(s) 140 used to identify the behaviors. In some embodiments, the behavior data may include data indicative of a plurality of these behaviors, such as at least any two of the behaviors, at least any three of the behaviors, at least any four of the behaviors, etc. In some embodiments, behavior may be represented by processed responses of quality survey instruments that are provided to pet owners.

The method 1100 may further include, at step 1106, receiving a trained neural architecture for a representation model configured to facilitate health condition predictions and another neural architecture for a classification model configured to predict a health condition of the pet based at least in part on the behavior data. The representation model may be an autoencoder neural architecture, configured to represent the behavior data from step 1104 in a lower dimensional embedding space. This representation is a form of feature engineering for the classification model, allowing all available behavior and/or auxiliary data to be leveraged while preserve key features related to the target health condition, and while removing noise from the input data that is unrelated to predicting the target health condition. The trained representation model and classification model may be received from, for example, a storage device associated with the platform 130 and/or the network 150 of FIG. 1. The trained model may be, for example, any of the XGBoost classification models 412 (e.g., one or more XGBoost classification models) trained on the embeddings from the autoencoder neural architectures 410 of FIG. 4, or it may be an additional neural architecture. For example, the trained neural architecture may be generated by the autoencoder 410 performing a dimensionality reduction on training data, such as the behavior data 404 contained in the table 300 of FIG. 3. In some examples, the neural architecture may be generated by generating a plurality of preliminary neural architectures, evaluating each of the preliminary neural architectures using one or more evaluation metrics, and selecting the neural architecture from the plurality of the preliminary neural architectures based on the evaluation metric. As described in connection with FIG. 5, the evaluation metric may include, for example, a vector distance between two cohorts of the training data determined by mapping the training data to a latent space.

In some embodiments, the trained classification model may further be configured to predict a health condition based, at least in part, on additional types of data such as demographic data (e.g., the demographic data 406 of FIG. 4) and/or auxiliary data (e.g., the auxiliary data 409 of FIG. 4). For example, the demographic data 406 and/or the auxiliary data 409 may be concatenated with the behavior data 404 before processing by the autoencoder 410, as described connection with FIG. 4, or the demographic data may be concatenated with the embedding space dimension coordinates that are output from the trained autoencoder model.

In some embodiments, the trained representation and classification models may further be configured to predict a health condition based, at least in part, on additional types of data such as known medical history of the pet, or such as genetic data for the pet obtained via DNA sequencing. For example, trained neural architectures may further be configured to predict a health condition based at least in part on a current and/or prior medical diagnosis or procedure the pet underwent obtained from a pet health record. Thus, particular behaviors and/or behavioral patterns associated with the prior diagnosis or procedure may be incorporated into the trained neural architecture.

In some embodiments, receiving the trained representation and classification models may include generating trained neural architectures, as described herein in connection with FIG. 2-9. In some embodiments, receiving the trained neural architectures may include accessing the trained neural architecture, for example, from a cloud-based service.

In some embodiments the trained neural architectures received at step 1106 may be selected for predicting a particular health condition, such as an ear infection, a renal infection, a dermatological disease, a weight-associated disease, a musculoskeletal disease, and/or arthritis. That is, the received trained neural architectures may be tailored to detect a particular health condition based on the behavioral data determined at step 1104.

In some embodiments, the trained neural architectures received at step 1106 may be selected based on one or more existing health conditions of the pet. For example, the received trained neural architectures may be tailored to a specific medical diagnosis or procedure that the pet underwent, as obtained for example from a pet health record. That is, the trained neural networks received at step 1106 may have been trained using data from other pets having the same health condition. In other embodiments, the received trained neural networks may be more general trained neural architectures configured to predict a health condition in a pet with no known diagnoses.

The method 1100 may further include, at step 1108, predicting, using the trained neural architectures generated at step 1106, the presence of the health condition of the pet. In some embodiments, the health condition may be at least one of an ear infection, a renal infection, a dermatological disease, a weight-associated disease, a musculoskeletal disease, and/or arthritis. However, the foregoing list is not to be construed as limiting, and potentially any health-related condition or diagnosis that can be modeled using the principles described herein may be the health condition. Feature engineering that facilitates a prediction may be performed by mapping the behavior data determined at step 1104 onto a dimensionally reduced latent space generated by the neural architectures (e.g., the map 500 of FIG. 5), and prediction may be performed by a classification model that leverages those latent space features as well as, possibly, auxiliary data, to classify the behavior data determined at step 1104 into one of two (or several) cohorts—i.e. whether the behavior data is consistent with the pet having the health condition, or whether the behavior data is consistent with the pet not having the health condition.

As discussed in connection with step 1104, the behavior data may include data indicative of at least two behaviors (such as eating, scratching, lying down, etc.), and, so the neural architecture utilizes a multifactorial analysis to predict the health condition. That is, the prediction of the health condition is based on a plurality of behaviors, rather than just a single behavior. The behaviors analyzed by the neural architecture to make the prediction may include behaviors conventionally associated with the health condition (e.g. scratching is conventionally associated with a dermatological disease), and also other behaviors not necessarily understood to be indicative of the health condition, but that may be discovered by the neural architectures to indeed be indicative of the health condition.

In some embodiments, the prediction determined as step 1108 may be treated as pre-diagnostic. That is, the prediction may be used as a basis for recommending further evaluation, such as an at-home diagnostic test or a veterinarian visit, but the prediction itself is not treated as a formal diagnosis of the health condition. In other embodiments, the prediction determined at step 1108 may be treated as a formal diagnosis of the health condition.

The method 1100 may further include, at step 1110, causing a user device to display a notification including information identifying the health condition. The user device may be, for example, the user device 110 of FIG. 1 and/or the user device of FIG. 10. The notification (e.g., the notification 1010 of the user interface 1000 of FIG. 10) may include a message indicating that the pet may have the health condition based on the prediction of step 1108. In some embodiments, the notification may include a recommendation for a course of action, such as observing the pet to confirm the health condition, administering an at-home test kit to confirm the health condition, and/or or visiting a veterinarian. In some embodiments, the notification may include one or more control elements (e.g., the one or more control elements 1012 of FIG. 10) allowing the user to execute the course of action, such as purchasing the at-home test kit from a retailer (e.g. an online retailer), or scheduling a veterinary appointment.

Although FIG. 11 shows example blocks of exemplary method 1100, in some implementations, the exemplary method 1100 may include additional blocks, fewer blocks, different blocks, or differently arranged blocks than those depicted in FIG. 11. Additionally, or alternatively, two or more of the blocks of the exemplary method 1100 may be performed in parallel, where context would allow.

FIG. 12 illustrates an exemplary method 1200 for training a machine learning model (e.g., the machine learning model 140 of FIG. 1 and/or the machine learning model 400 of FIG. 4) according to embodiments of the present disclosure. Each of steps 1202-1208 of the method 1200 may be performed by at least one processor of the system 100 of FIG. 1, such as at least one processor associated with the platform 130.

The method 1200 may include, at step 1202, receiving at least one set of training data. The training may include the input data 402 of FIG. 4 including the behavior data 404 and the cohort data 408. In some embodiments, the training data may further include the demographic data 406 and/or the auxiliary data 409. However, as described herein in connection with FIGS. 4-9, the neural architectures may be generated and trained without the demographic data 406 and/or the auxiliary data 409 in some embodiments.

The method 1200 may further include, at step 1204, training the machine learning model based on the at least one set of training data to generate a plurality of neural architectures that form a representation model. Training the machine learning model may include processing the training data with the autoencoder 410 to generate the plurality of neural architectures. Architectures may be optimized via neural architecture search and optimization methods, such as Bayesian optimization, to achieve specific autoencoders that efficiently embed the training data in reduced dimensional space that preserves and highlights features of the input data relevant for predicting the target health condition. Classification model 412 may then use the dimensional coordinates from the embedded dimensions output from model 410 as input features to predict the target health condition, as discussed herein in connection with FIG. 4. Training the machine learning model may further include evaluating the plurality of neural architectures using an evaluation metric, as discussed herein in connection with FIGS. 4-5. The evaluation metric may be used as an objective function in evolving neural architectures that maximize or minimize the evaluation metric. In some embodiments, training the machine learning model may further include receiving and/or generating auxiliary data, concatenating the auxiliary data to the original training data received at step 1202, and generating a new plurality of neural architectures based on the concatenated training data. For example, as discussed herein in connection with FIGS. 4-6, the neural architectures or other classification models 412 generated based on the input data 402 may be utilized to generate additional data (e.g., the data in table 600) as the auxiliary data 409. Similarly, as discussed herein in connection with FIG. 9, machine learning techniques such as PCA may be used to generate additional data (e.g., the data in the map 900), which may be utilized as the auxiliary data 409. The auxiliary data 409 may then be concatenated with the behavior data 404 and re-processed by the autoencoder 410 to generate new neural architectures or other classification models 412. The new neural architectures or other classification models 412 may in turn be evaluated, based on one or more evaluation metrics.

The method 1200 may further include, at step 1206, selecting one of the neural architectures for storage as a trained neural architecture. The trained neural architecture may be the architecture receiving the highest evaluation score out of the plurality of neural architectures 412 generated at step 1204.

The method 1200 may further include, at step 1208, storing the trained neural architecture. In particular, the trained neural architecture may be stored on a storage device associated with the platform 130 and/or the network 150. Once stored, the machine learning model can be retrieved and/or received, for example by a processor associated with the platform 130.

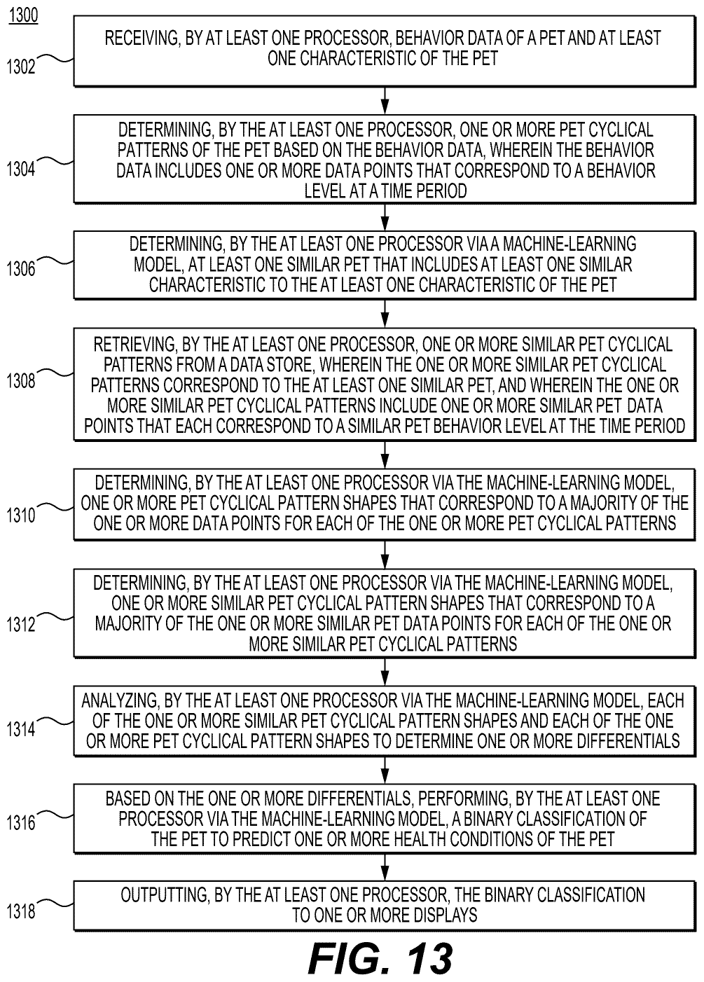

FIG. 13 illustrates an exemplary method 1300 for training a machine learning model (e.g., the machine learning model 140 of FIG. 1, the machine learning model 400 of FIG. 4, and/or the binary classifier 412 of FIG. 4) according to one or more embodiments of the present disclosure. Each of steps 1302-1318 of the method 1300 may be performed by at least one processor of the system 100 of FIG. 1, such as at least one processor associated with the platform 130.

The method 1300 may include, at step 1302, receiving, by at least one processor, behavior data (e.g., behavior data 404) of a pet and at least one characteristic of the pet. In some embodiments, the behavior data may be based on the activity data collected by at least one sensor device (e.g., sensing device(s) 120 of FIG. 1). The activity data may include, for example, the output signal (e.g., output voltage) of an accelerometer (see FIG. 2) associated with the smart collar 122 of FIG. 1. The characteristic may include demographic data (e.g., demographic data 406) and/or auxiliary data (e.g., auxiliary data 409).

In some embodiments, all or some of the behavior data may be received from a data store that previously received, stored, and/or associated all or some of the behavior data with the pet. Additionally, the at least one characteristic of the pet may have been previously received, stored, and/or associated with the pet.

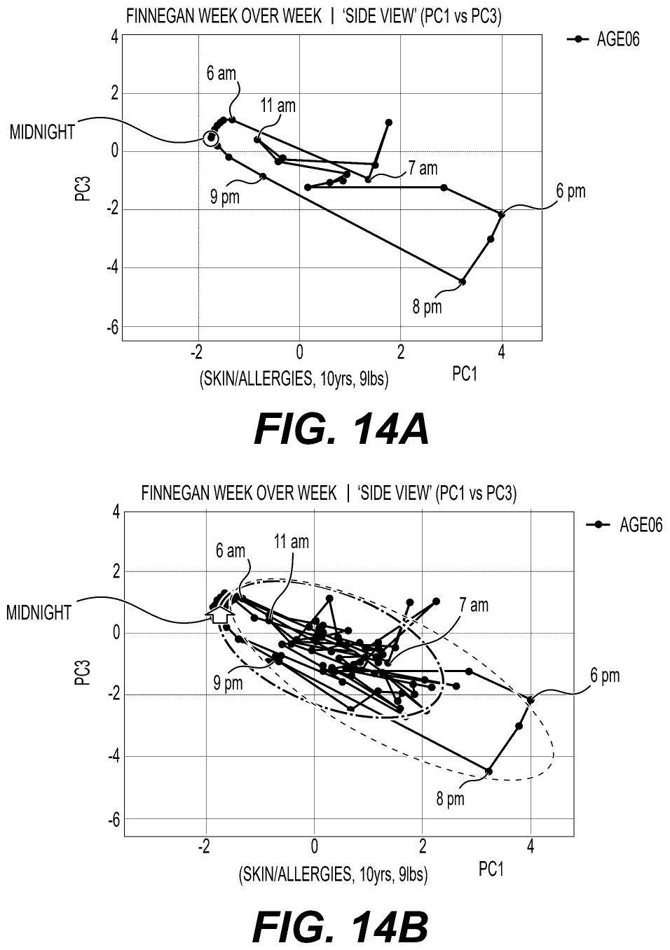

The method may further include, at step 1304, determining, by the at least one processor, one or more pet cyclical patterns of the pet based on the behavior data, wherein the behavior data includes one or more data points that correspond to a behavior level at a time period. For example, as discussed previously, the behavior data may include activity data, where the behavior level at a time period may correspond to an activity level at particular point in time. Each of the pet cyclical patterns may include an average activity level for the same time period for a number of days, weeks, months, and the like. For example, as shown in FIG. 14A, a pet cyclical pattern may include a pet's average composite behavior at 12 am, 6 am, 7 am, 11 am, 8 pm, and 9 pm for each day, where the composite includes minutes of scratching, licking, eating, drinking, etc., within the hour, and these behaviors are combined into a reduced dimensional embedding space, such as from training an autoencoder on the behaviors, as described above. The pet cyclical pattern may include one data point at each time period (e.g., 12 am, 6 am, 7 am, 11 am, 8 pm, and 9 pm), where each data point may correspond to the pet's average behavior at the specific time for seven days. Additionally, each of the pet cyclical patterns may correspond to an activity level of the pet at the same point in time, but over a different time range. For example, each of the pet cyclical patterns may correspond to the pet's average composite behavior at 12 am, 6 am, 7 am, 11 am, 8 pm, and 9 pm for a different set of seven days.

The method may further include, at step 1306, determining, by the at least one processor via the machine learning model, at least one similar pet that includes at least one similar characteristic to the at least one characteristic of the pet. For example, the characteristic may correspond to one or more physical attributes of the pet (e.g., long ears, short tail), demographic data (e.g., demographic data 406), and/or one or more physical conditions of the pet (e.g., allergies). The method may include accessing a data store that includes characteristics of other pets. The method may further include analyzing the stored characteristics to determine one or more characteristics that are similar to those of the pet. For example, a machine learning model may analyze the stored characteristics of the other pets and the characteristics of the pet to find at least one pet that includes similar characteristics to those of the pet.

Upon determining one or more similar pets, the data store may receive a request for data corresponding to the one or more similar pets that are associated with the at least one similar characteristic. For example, the request may include the similar characteristic of the similar pets. In response to receiving the request, the one or more data stores may output data corresponding to the one or more similar pets. For example, the output data may include a unique identifier for each of the similar pets, a behavior label for each of the similar pets, and/or one or more cyclical patterns for each of the similar pets. The unique identifier may be associated with each pet in the one or more data stores. The behavior label may correspond to a health condition of the similar pet. In some embodiments, the behavior label may include cohort data (e.g., cohort data 408). For example, the behavior label may include a Body Conditioning Score (BCS) for the similar pet.

The method may further include, at step 1308, retrieving, by the at least one processor, one or more similar pet cyclical patterns from a data store, wherein the one or more similar pet cyclical patterns correspond to the at least one similar pet, and wherein the one or more similar pet cyclical patterns include one or more similar pet data points that each correspond to a similar pet behavior level at the time period. The data store may receive a request that includes the unique identifier for each similar pet and/or a particular behavior label. For example, the request may include a behavior label corresponding to a BCS score of “3”. In response to receiving the request, the data store may output one or more cyclical patterns that correspond to the similar pet.

Each similar pet may include at least one cyclical pattern that includes one or more data points that may each correspond to a behavior level at a time period. In some embodiments, the one or more data points may correspond to average hourly data across one or more days. The data points may each correspond to an activity level at a period of time. For example, the similar pet cyclical pattern may include one data point at each time period (e.g., 12 am, 6 am, 7 am, 11 am, 8 pm, and 9 pm), where each data point corresponds to the similar pet's average behavior (e.g., composite behavior) at the specific time for seven days. Additionally, each of the similar pet cyclical patterns may correspond to an activity level of the similar pet at the same point in time, but over a different time range. For example, each of the similar pet cyclical patterns may correspond to the similar pet's average composite behavior at 12 am, 6 am, 7 am, 11 am, 8 pm, and 9 pm for a different set of seven days.

Additionally, for example, in response to receiving the request for the similar pets associated with the at least one similar characteristic, the data store may output the one or more similar pet cyclical patterns. The retrieving may include querying the data store for the similar pet cyclical patterns that correspond to the similar pets for the same time period as the cyclical pattern for the pet. For example, the retrieving may include sending a query for each of the similar pet cyclical patterns to the data store, where the query may include the unique pet identifier, a behavior type (e.g., licking behavior) and a time period for the data included in the similar pet cyclical pattern (e.g., 12 am, 6 am, 7 am, 11 am, 8 pm, and 9 pm for a set of seven days).

In some embodiments, the method may further include outputting, by the at least one processor, the one or more pet cyclical patterns of the pet and the one or more similar pet cyclical patterns of the at least one similar pet to at least one display. For example, the pet cyclical patterns and the similar pet cyclical patterns may be displayed on a user interface of a user device. The user interface may display some or all of the data points of the pattern. Additionally, the user interface may also display a connector (e.g., a line) that may connect the data points to each other.

The method may further include, at step 1310, determining, by the at least one processor via the machine learning model, one or more pet cyclical pattern shapes that correspond to a majority of the one or more data points for each of the one or more pet cyclical patterns. The shape may represent a time-windowed behavior of the pet. The machine learning model may analyze the shape of the cyclical pattern to determine the shape that best fits the majority of the data points of the cyclical pattern. The cyclical pattern shape may or may not include all of the data points. The machine learning model may analyze the cyclical pattern shape to determine at least one outlier data point, where the outlier data point may not be included in the cyclical pattern shape. The shape may include an ellipsoid, a rectangle, square, triangle, a single vector, and the like. For example, as shown in FIG. 14B, an ellipsoid may fit the majority, but not all of the data points of the cyclical pattern shape.

The method may further include, at step 1312, determining, by the at least one processor via the machine learning model, one or more similar pet cyclical pattern shapes that correspond to a majority of the one or more similar pet data points for each of the one or more similar pet cyclical patterns. The similar pet shape may represent time-windowed behavior of each of the similar pets. The machine learning model may also analyze the similar pet cyclical patterns to determine a shape for each for each of the patterns. The similar pet cyclical pattern shape may or may not include all of the data points. The machine learning model may analyze the cyclical pattern shape to determine at least one outlier data point, where the outlier data point may not be included in the cyclical pattern shape.

In some embodiments, the method may further include applying, by the at least one processor, the one or more pet cyclical pattern shapes to the output one or more pet patterns. For example, the user interface may display an outline and/or a filled in outline of the shape over the cyclical pattern of the pet. The method may further include applying, by the at least one processor, the one or more similar pet cyclical pattern shapes to the output one or more similar pet patterns. For example, the user interface may also display an outline and/or a filled in outline of the shape over the cyclical pattern of the similar pets.

The method may further include, at step 1314, analyzing, by the at least one processor via the machine learning model, each of the one or more similar pet cyclical pattern shapes and each of the one or more pet cyclical pattern shapes to determine one or more differentials. The differentials may indicate a change in a pet's behavior and/or how the pet's behavior compares to expected pet behavior (e.g., the behavior of the similar pets). For example, the analyzing may include utilizing an algorithm to compare the one or more similar pet cyclical pattern shapes and each of the one or more pet cyclical pattern shapes to determine the one or more differentials. The differentials may indicate that a shape stretched, shrank, and/or shifted in relation to the other shapes. For example, the differentials may include a differential between an x-axis value, a y-axis value, and/or a z-axis value of the similar pet cyclical pattern shape and the pet cyclical pattern shape.

In some embodiments, the analyzing may include determining a shape shifting direction to determine one or more behavior changes. For example, the direction of the shape shifting may indicate that the pet has increased or decreased the amount of scratching.

In some embodiments, the analyzing may include determining one or more relationships between the one or more pet cyclical pattern shapes and the one or more similar pet cyclical pattern shapes. For example, the machine learning model may be trained by analyzing the one or more similar pet cyclical pattern shapes, the one or more pet cyclical pattern shapes, the one or more differentials, the behavior label for each of the pets and/or the behavior labels for each of the similar pets, and/or the one or more behavior changes to determine a relationship between the one or more pet cyclical pattern shapes and the one or more similar pet cyclical pattern shapes.

The method may further include, at step 1316, based on the one or more differentials, performing, by the at least one processor via the machine learning model, a binary classification of the pet to predict one or more health conditions of the pet. In some embodiments, the machine learning model may perform a binary classification of the pet based on the learned one or more relationships between the one or more pet cyclical pattern shapes and the one or more similar pet cyclical pattern shapes. Additionally, or alternatively, the machine learning model may perform a binary classification of a different pet based on the learned one or more relationships between the one or more pet cyclical pattern shapes and the one or more similar pet cyclical pattern shapes. For example, the machine learning model may be utilized as the trained neural architecture in step 1106 of FIG. 11 to predict a health condition of the pet.

The method may further include, at step 1318, outputting, by the at least one processor, the binary classification to one or more displays. The binary classification may include information identifying a health condition of the pet. For example, as described in step 1110 of FIG. 11, the outputting may include causing a user device to display a notification including information identifying the health condition of the pet.

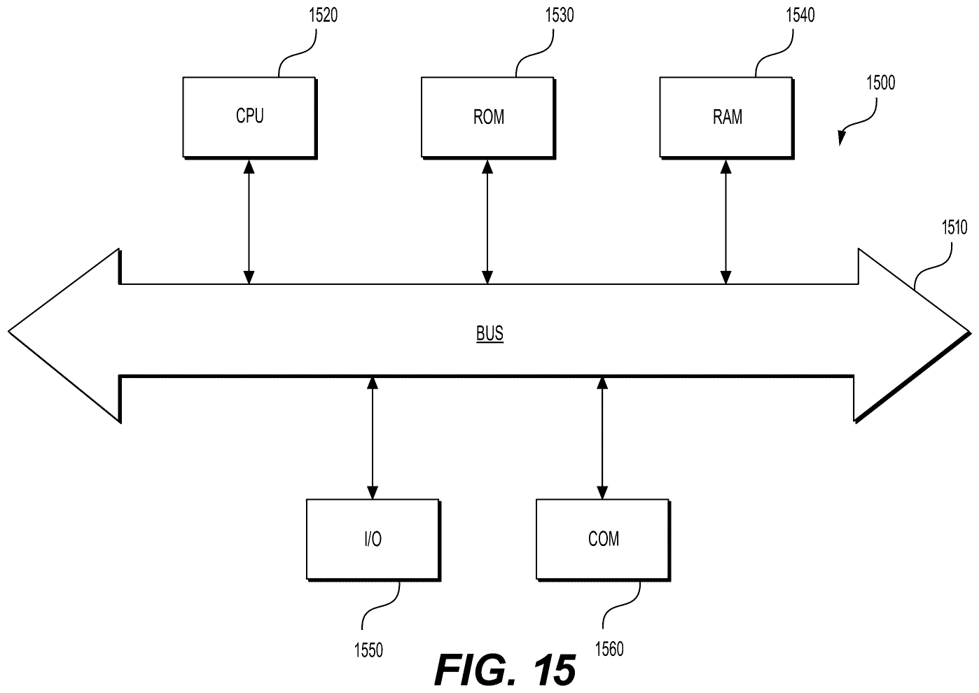

FIG. 15 is a simplified functional block diagram of a computer that may be configured as a device 1500 for executing the techniques and/or methods of FIGS. 4-14B, according to exemplary embodiments of the present disclosure. For example, device 1500 may include a central processing unit (CPU) 1520. CPU 1520 may be any type of processor device including, for example, any type of special purpose or a general-purpose microprocessor device. As will be appreciated by persons skilled in the relevant art, CPU 1520 also may be a single processor in a multi-core/multiprocessor system, such system operating alone, or in a cluster of computing devices operating in a cluster or server farm. CPU 1520 may be connected to a data communication infrastructure 1510, for example, a bus, message queue, network, or multi-core message-passing scheme.

Device 1500 also may include a main memory 1540, for example, random access memory (RAM), and also may include a secondary memory 1530. Secondary memory 1530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to the removable storage drive. As will be appreciated by persons skilled in the relevant art, such a removable storage unit generally includes a computer usable storage medium having stored therein computer software and/or data.

In alternative implementations, secondary memory 1530 may include other similar means for allowing computer programs or other instructions to be loaded into device 1500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 1500.

Device 1500 also may include a communications interface (“COM”) 1560. Communications interface 1560 allows software and data to be transferred between device 1500 and external devices. Communications interface 1560 may include a modem, a network interface (such as an Ethernet card), a communications port, a PCMCIA slot and card, or the like. Software and data transferred via communications interface 1560 may be in the form of signals, which may be electronic, electromagnetic, optical, or other signals capable of being received by communications interface 1560. These signals may be provided to communications interface 1560 via a communications path of device 1500, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 1500 also may include input and output ports 1550 to connect with input and output devices such as keyboards, mice, touchscreens, monitors, displays, readable media (e.g., barcode or QR code) scanner, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

A computer system, such as a system or device implementing a process or operation in the examples above, may include one or more computing devices. One or more processors of a computer system may be included in a single computing device or distributed among a plurality of computing devices. A memory of the computer system may include the respective memory of each computing device of the plurality of computing devices.

A computer may be configured as a device for executing the exemplary embodiments of the present disclosure. For example, the computer may be configured according to exemplary embodiments of this disclosure. In various embodiments, any of the systems herein may be a computer including, for example, a data communication interface for packet data communication. The computer also may include a central processing unit (“CPU”), in the form of one or more processors, for executing program instructions. The computer may include an internal communication bus, and a storage unit (such as ROM, HDD, SDD, etc.) that may store data on a computer readable medium, although the computer may receive programming and data via network communications. The computer may also have a memory (such as RAM) storing instructions for executing techniques presented herein, although the instructions may be stored temporarily or permanently within other modules of computer (e.g., processor and/or computer readable medium). The computer also may include input and output ports and/or a display to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Furthermore, while some embodiments described herein include some but not other features included in other embodiments, combinations of features of different embodiments are meant to be within the scope of the invention, and form different embodiments, as would be understood by those skilled in the art.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for predicting pet health conditions, the method comprising:
receiving, by at least one processor, activity data generated by at least one sensor device configured to detect activity of a pet;
determining, by the at least one processor, behavior data indicative of a plurality of behaviors of the pet based on the activity data;
receiving, by the at least one processor, a trained neural architecture for a representation model configured to facilitate health condition predictions and another neural architecture for a classification model configured to predict a health condition of the pet based at least in part on the behavior data;
predicting, by the at least one processor using the trained neural architecture, presence of the health condition of the pet; and
causing, by the at least one processor, a user device to display a notification including information identifying the health condition.

2. The method of claim 1, wherein the plurality of behaviors comprises at least two of drinking, eating, scratching, licking, and lying down.

3. The method of claim 1, wherein the health condition comprises at least one of an ear infection, a renal infection, a dermatological disease, a dermatological disease, a weight-associated disease, a musculoskeletal disease, and arthritis.

4. The method of claim 1, wherein the neural architecture for the representation model is generated by:
generating, by the at least one processor, a plurality of preliminary neural architectures;
evaluating, by the at least one processor, each of the preliminary neural architectures using an evaluation metric; and
selecting, by the at least one processor, the neural architecture from the plurality of preliminary neural architecture based on the evaluation metric.

5. The method of claim 1, wherein the neural architecture for the representation model is generated by:
performing, by the at least one processor utilizing an autoencoder or other dimensionality reduction model, a dimensionality reduction of training data provided to the machine learning model.

6. The method of claim 1, wherein determining the behavior data of the pet based on the activity data is performed using a machine learning model.

7. The method of claim 1, further comprising:
receiving, by the at least one processor, demographic data or genetic data including at least one of a gender of the pet, a height of the pet, and a weight of the pet,
wherein predicting the presence of a health condition of the pet is based at least in part on the demographic data.

8. The method of claim 1, wherein the notification comprises a recommendation to perform a diagnostic test to confirm the prediction of the health condition.

9. A computer system for predicting pet health conditions, the system comprising:
at least one memory having processor-readable instructions stored therein; and
at least one processor configured to access the at least one memory and execute the processor-readable instructions, which when executed by the at least one processor cause the at least one processor to perform a plurality of functions, including functions for:
receiving activity data generated by at least one sensor device configured to detect activity of a pet;
determining behavior data indicative of a plurality of behaviors of the pet based on the activity data;
receiving a trained neural architecture for a representation model configured to facilitate health condition predictions and another neural architecture for a classification model configured to predict a health condition of the pet based at least in part on the behavior data;
predicting, using the trained neural architecture, presence of the health condition of the pet; and
causing a user device to display a notification including information identifying the health condition.

10. The system of claim 9, wherein the plurality of behaviors comprises at least two of drinking, eating, scratching, licking, and lying down.

11. The system of claim 9, wherein the health condition comprises at least one of an ear infection, a renal infection, a dermatological disease, a dermatological disease, a weight-associated disease, a musculoskeletal disease, and arthritis.

12. The system of claim 9, wherein the neural architecture for the representation model is generated by:
generating, by the at least one processor, a plurality of preliminary neural architectures;
evaluating, by the at least one processor, each of the preliminary neural architectures using an evaluation metric; and
selecting, by the at least one processor, the neural architecture from the plurality of preliminary neural architecture based on the evaluation metric.

13. The system of claim 9, wherein the neural architecture for the representation model is generated by:
performing, by the at least one processor utilizing an autoencoder or other representation model, a dimensionality reduction of training data provided to the machine learning model.

14. The system of claim 9, wherein the plurality of functions further include functions for:
receiving, by the at least one processor, demographic data or genetic data including at least one of a gender of the pet, a height of the pet, and a weight of the pet,
wherein predicting the presence of a health condition of the pet is based at least in part on the demographic data.

15. The system of claim 9, wherein the notification comprises a recommendation to perform a diagnostic test to confirm the prediction of the health condition.

16. A non-transitory computer-readable medium configured to store instructions that, when executed by at least one processor of a device for predicting pet health conditions, cause the at least one processor to perform operations comprising:
receiving activity data generated by at least one sensor device configured to detect activity of a pet;
determining behavior data indicative of a plurality of behaviors of the pet based on the activity data;
receiving a trained neural architecture for a representation model configured to facilitate health condition predictions and another neural architecture for a classification model configured to predict a health condition of the pet based at least in part on the behavior data;
predicting, using the trained neural architecture, presence of the health condition of the pet; and
causing a user device to display a notification including information identifying the health condition.

17. The non-transitory computer-readable medium of claim 16, wherein the neural architecture is generated by:
generating, by the at least one processor, a plurality of preliminary neural architectures;
evaluating, by the at least one processor, each of the preliminary neural architectures using an evaluation metric; and
selecting, by the at least one processor, the neural architecture from the plurality of preliminary neural architecture based on the evaluation metric.

18. The non-transitory computer-readable medium of claim 16, wherein the neural architecture is generated by:
performing, by the at least one processor utilizing an autoencoder or other dimensionality reduction model, a dimensionality reduction of training data provided to the machine learning model.

19. The non-transitory computer-readable medium of claim 16, wherein the operations further comprise:
receiving, by the at least one processor, demographic data or genetic data including at least one of a gender of the pet, a height of the pet, and a weight of the pet,
wherein predicting the presence of a health condition of the pet is based at least in part on the demographic data.

20. The non-transitory computer-readable medium of claim 16, wherein the notification comprises a recommendation to perform a diagnostic test to confirm the prediction of the health condition.

21. A computer-implemented method for training a machine learning model to predict a pet health condition, the computer-implemented method comprising:
receiving, by at least one processor, behavior data of a pet and at least one characteristic of the pet;
determining, by the at least one processor, one or more pet cyclical patterns of the pet based on the behavior data, wherein the behavior data includes one or more data points that correspond to a behavior level at a time period;
determining, by the at least one processor via a machine learning model, at least one similar pet that includes at least one similar characteristic to the at least one characteristic of the pet;
retrieving, by the at least one processor, one or more similar pet cyclical patterns from a data store, wherein the one or more similar pet cyclical patterns correspond to the at least one similar pet, and wherein the one or more similar pet cyclical patterns include one or more similar pet data points that each correspond to a similar pet activity level at the time period;
determining, by the at least one processor via the machine learning model, one or more pet cyclical pattern shapes that correspond to a majority of the one or more data points for each of the one or more pet cyclical patterns;
determining, by the at least one processor via the machine learning model, one or more similar pet cyclical pattern shapes that correspond to a majority of the one or more similar pet data points for each of the one or more similar pet cyclical patterns;
analyzing, by the at least one processor via the machine learning model, each of the one or more similar pet cyclical pattern shapes and each of the one or more pet cyclical pattern shapes to determine one or more differentials;
based on the one or more differentials and labels associated with each pet and/or similar pet, performing, by the at least one processor via the machine learning model, a binary classification of the pet to predict one or more health conditions of the pet; and
outputting, by the at least one processor, the binary classification to one or more displays.

22. The computer-implemented method of claim 21, wherein the one or more data points correspond to average hourly data across one or more days.

23. The computer-implemented method of claim 21, wherein analyzing each of the one or more similar pet cyclical pattern shapes and each of the one or more pet cyclical pattern shapes to determine the one or more differentials includes utilizing an algorithm to compare the one or more similar pet cyclical pattern shapes and each of the one or more pet cyclical pattern shapes.

24. The computer-implemented method of claim 21, wherein the analyzing includes determining a shape shifting direction based on the one or more differentials to determine one or more behavior changes.

25. The computer-implemented method of claim 21, wherein the analyzing includes determining, by the machine learning model, one or more relationships between the one or more pet cyclical pattern shapes and the one or more similar pet cyclical pattern shapes.

26. The computer-implemented method of claim 21, the computer-implemented method further comprising:
outputting, by the at least one processor, the one or more pet cyclical patterns of the pet and the one or more similar pet cyclical patterns of the at least one similar pet to the one or more displays.

27. The computer-implemented method of claim 26, the computer-implemented method further comprising:
applying, by the at least one processor, the one or more pet cyclical pattern shapes to the output one or more pet patterns; and
applying, by the at least one processor, the one or more similar pet cyclical pattern shapes to the output one or more similar pet patterns.

28. The computer-implemented method of claim 21, wherein the behavior data include activity data, and wherein the activity data is generated by at least one sensor device configured to detect activity of the pet.
